(19) United States
(12) Patent Application Publication
(10) Pub. No.: US 2011/0000917 A1
(43) Pub. Date: Jan. 6, 2011

(54) COVER AND METHOD FOR THE PRODUCTION THEREOF

(75) Inventors: Detlef Wolters, Muellheim (DE); Roland Loebelt, Ettenheim (DE)

Correspondence Address: RATNERPRESTIA, P.O. BOX 980, VALLEY FORGE, PA, 19482, US

(73) Assignee: Amcor Flexibles Kreuzlingen Ltd., Kreuzlingen (CH)

(21) Appl. No.: 12/865,960

(22) PCT Filed: Jan. 19, 2009
(86) PCT No.: PCT/EP09/00292

§ 371 Date: Aug. 3, 2010

(30) Foreign Application Priority Data
Feb. 5, 2008 (EP) 08405031.9
Mar. 27, 2008 (CH) 00446/08

(51) Int. Cl. B65D 51/00; B23P 17/04

(52) U.S. Cl. 220/376; 29/592

(57) ABSTRACT

In a cover made of a carrier material and a sealing layer which faces inwardly in relation to a container on which the cover is used and is made of a sealing lacquer printed on the carrier material to close the container having a shoulder, the inwardly facing side of the carrier material has the sealing layer in the form of a print image corresponding to the shoulder of the container, and a print pattern made of a sealing lacquer or polymer-containing lacquer is printed on the carrier material inside the region limited by the sealing layer The thickness (b) of the print pattern printed onto the carrier material is greater than the thickness (a) of the sealing layer.

### CROSS-REFERENCE TO RELATED APPLICATIONS

This application is a U.S. National Phase Application of PCT International Application PCT/EP2009/000292, filed 19 Jan. 2009 and published 13 Aug. 2009 as WO 2009/097961, which claims priority from European Application EP 08405031.9, filed 5 Feb. 2008, and Swiss Application CH 00446/08, filed 27 Mar. 2008, each of which is incorporated herein by reference in its entirety for all purposes.

### FIELD OF THE INVENTION

The invention relates to a cover made of a carrier material and a sealing layer, which faces inwardly in relation to a container on which the cover is used and is made of a sealing lacquer, which is printed on the carrier material, for closing the container having a shoulder, the side of the carrier material facing inwardly having the sealing layer in the form of a print image corresponding to the shoulder of the container, and a print pattern made of a sealing lacquer or polymer-containing lacquer being printed on the carrier material inside the region limited by the sealing layer. A method for producing the covers is also within the scope of the invention.

### BACKGROUND OF THE INVENTION

It is known to provide containers, such as, for example deep-drawn, injection-moulded or otherwise formed containers with a level annular shoulder on their opening and to provide such containers, in particular after filling, with a cover, the cover resting over the entire area on the shoulder and being fastened, for example by sealing or gluing to the shoulder in a peelable and sealing manner. Such containers, bowls, menu bowls, for example with one or more compartments, pots, small packagings etc. are known, for example, for packaging foods of all types, such as, for example, milk products, in particular yoghurt, whipping cream, sour milk, sour cream, coffee cream, ready preparations of salads or semi-preserved or fully preserved foods, precooked or otherwise prepared dishes, drinks such as fruit and vegetable juices or drinking water.

The covers are punched, for example, out of a continuously available cover material and stacked. The cover stacks are fed to a packaging machine and the separated or unstacked covers are continuously sealed onto the already filled containers. The covers provided with a sealing layer are sealed by means of a sealing tool in the shoulder region of the container on the container edge. The separation or unstacking of the covers by removal from the cover stack is not always carried out reliably by the packaging machines as the covers lying against one another can undesirably adhere to one another. For example, the effect of adhering to one another can be prevented by an embossing of the cover material. Embossings on the cover material, however, have a negative effect on the print image on the outside of the covers.

The cover material may consist of the most varied materials, depending on the requirements. Typical examples are metal foils, which are coated with plastics material on one or both sides. Other cover materials contain or consist of plastics materials in the form of mono films or multi-layer laminates. Further cover materials may be made of cellulose-containing materials, such as cellulose film or paper. Laminates of metal foils and plastics material films are also used. In order to seal the cover material to the container edge, the cover material is provided over the entire area with a sealing layer, such as a sealing lacquer or a sealing foil, the sealing layer being applied, for example, at least to the side facing inwardly on the finished packaging, i.e. facing toward the container interior.

The cover material is furthermore used as an information and advertising carrier. For this reason, the cover material is provided with a print on its outside. The printing may be arranged on the uppermost layer facing outwardly on the finished container, as so-called front-side printing. The printing may also be covered with a protective lacquer or with a protective film or the uppermost layer of the cover material may be made of transparent material and be printed on the rear (so-called reverse printing). The print images may be single-coloured or multi-coloured and be applied in a printing machine.

The cover material is produced, for example, in such a way that a carrier, such as a metal foil or a plastics material film or a plastics material film composite is processed by lamination or calendering with one or more further layers into a multi-layer composite. The sealing layer is applied to the side of the cover material facing inwardly on the finished container by lacquering or lamination. After these processing steps, the cover material present, for example, as coils, is guided through a printing machine. On the side of the cover material later facing outwardly on the container a further printing can thus be provided. Furthermore, an embossing step is provided, which gives the cover material, for example, a worm embossing.

A cover material for containers is disclosed in EP-A-0 847 933, the sealing layer being applied in the form of a print image to the cover material and the print image corresponding to the shoulder region of the container. The cover material is sealed by means of the sealing layer against the shoulder region of the container.

### BRIEF SUMMARY OF THE INVENTION

The drawback in earlier known methods for producing cover materials is the high material outlay to cover the cover material over the whole area with sealable material although only a small percentage of this sealable material is ultimately used for the sealing seam. In the cases presently described, the cover material has to be embossed and the embossed cover material or the covers produced therefrom only represent the print image disadvantageously.

A cover made of carrier material is known from EP-A-0 983 947, in which the side of the carrier material facing inwardly has a sealing layer in the form of a print image corresponding to the shoulder of the container and a print pattern made of a sealing lacquer or a polymer-containing lacquer is printed onto the carrier material inside the region limited by the sealing layer. It is to be possible for stacked covers to be separated without problems with the print pattern.

The invention is based on the object of proposing a cover of the type mentioned at the outset, which allows economical use of sealing lacquer, which can be reliably separated from a cover stack and can be produced in a material-saving manner without quality losses.

The fact that the thickness of the print pattern printed onto the carrier material is greater than the thickness of the sealing layer leads to the achievement of the object according to the invention.

### BRIEF DESCRIPTION OF THE DRAWINGS

FIG. 1 shows the plan view of the inside of a cover with an annular print pattern.

FIG. 2 shows a section through the cover of FIG. 1 provided for sealing against the edge of a container, along the line I-I.

FIGS. 3 to 5 show the plan view of the inside of covers of further print patterns.

FIG. 6 shows the plan view of a foil with an arrangement of covers according to FIG. 1.

FIG. 7 shows a plan view of an arrangement of annular print patterns with a print geometry rotating in the foil running direction.

### DETAILED DESCRIPTION OF THE INVENTION

The height of the print pattern is preferably 3 to 7 times, in particular 4 to 6 times, the height of the sealing layer. The height of the sealing layer is expediently about 2 to 5 μm and the height of the print pattern about 15 to 30 μm.

In order to reliably ensure optimal support of the covers in a stack, the sealing layer may have a number of substantially point-shaped elevations preferably distributed uniformly over the periphery of the sealing layer. This ensures that the cover edges cannot bend. For example, at least three and, in particular, at least four elevations may be present. An upper limitation of the number of elevations is not very critical and, may, for example, be up to a number of 20 elevations. Three to eight and, particularly advantageously, four to six elevations are advantageous.

The height of the elevations over the carrier material preferably substantially corresponds to the height of the print pattern.

The carrier material may be a mono film made of plastics material or a multi-layer composite made of two or more plastics material layers or a metal foil or a multi-layer composite of at least one metal foil or/and at least one plastics material film. The carrier material may also consist of cellulose-containing material or contain cellulose-containing material. The cellulose-containing material may be coated on one or both sides, for example with plastics material, or may be metallised or may, on one side, have a plastics material layer and, on the other side, have a metallised layer. The plastics materials of the carrier material may, for example, be a polyolefin, such as polyethylene (PE) or polypropylene (PP), polyamide (PA), polyethylene terephthalate (PET) or polyvinyl chloride (PVC). Steel or aluminium foils may be used, for example, as metal foils. Examples of cellulose-containing materials which can be used are papers or thin board. Further carrier materials are, for example, cellulose films. The carrier material may have a thickness of, for example, 12 to 500 μm, the carrier materials made of plastics material films or of metal foils or of metal and plastics material foils preferably having a thickness of 12 to 150 μm, while cover materials containing cellulose-containing materials have a thickness of 40 to 500 μm, for example. The carrier materials are, in particular, flexible in such a way that they can be wound into coils.

Preferred carrier materials contain a transparent, opaque or light-impermeable film or a film composite made of at least one plastics material from the range of polyester, polyolefins, such as polyethylene or polypropylene, polyamide or cellulose film or of a metal foil or of a metal foil coated with plastics material or a layer material made of paper with a plastics material layer, such as, for example, a PET layer, which may in turn be metallised.

The carrier material may also have a barrier layer against gases, vapours and moisture. Barrier layers may—apart from the metal foils mentioned—for example be films made of plastics material, such as polyvinylidene chloride (PVDC) or ethyl-vinyl alcohol (EVOH) or the latter may be a layer of ceramic materials, such as the oxides or nitrides of silicon or aluminium, which have been deposited in a thin layer, for example in the range of 10 to 500 nm, by a thin layer vacuum method onto a carrier foil. Examples of further barriers layers are metallic layers, for example made of aluminium, which are deposited by sputtering on the carrier.

Printing may be arranged on the side of the cover facing outwardly on the later finished container. The printing of the carrier material may be carried out by all the known printing methods, thus, for example, letterpress, offset printing, flexoprinting, screen printing, hello printing and copper gravure printing. The selection as to which printing method is used depends on the desired print quality, on the respective technical facts and the size of the print run. Flexoprinting (also called aniline or rubber printing), the UV flexo method and gravure printing, such as copper gravure printing or helio printing are preferred. The printing on the outside of the carrier material may, for example, be additionally over-lacquered by means of a protective lacquer, or a transparent film, for example made of polyethylene terephthalate, polyamide, polyolefins, such as polyethylene or polypropylene or a cellulose film layer, which is then, however, generally printed in reverse printing to improve the protection of the print image, can also be laminated onto the carrier material by means of an auxiliary laminating means or an adhesive.

A sealing layer and a print pattern are provided on the side of the cover facing the inside of the container on a finished container. The sealing layer and the print pattern are provided in the form of print images on the carrier material. The sealing layer can be applied to the carrier material in an upstream or downstream printing machine, i.e. before or after the production of the outside print image. The print pattern can be applied in the same or an upstream or downstream printing machine, i.e. be applied to the carrier material simultaneously with, before or after the production of the sealing layer. The print pattern is expediently applied with the same printing plate, which prints the sealing layer. The print pattern may advantageously be made of a primer and/or adhesion promoter and a sealing lacquer or may only be made of a sealing lacquer. The use of a primer or adhesion promoter and a sealing lacquer is preferred. The adhesion promoter or the primer and the sealing lacquer are applied consecutively in a printing machine, for example, by a letterpress printing, offset printing, flexoprinting, screen printing, helio printing, gravure or copper gravure printing, preferably by a flexo or gravure printing, to the carrier material. The print pattern has a high negative fraction, which means that, for example, only 0.1 to 20%, expediently 1 to 10%, of the face of the cover facing inwardly is covered with the print pattern and the remaining face is free of the print pattern.

The print pattern is preferably built up from circular ring segments arranged on circles lying concentrically with respect to one another. The print pattern may also be a uniformly or non-uniformly distributed point or line pattern.

The sealing layer, like the print pattern, may contain a sealing lacquer or consist thereof. Examples of polymers suitable for the sealing layer and the print pattern are polyolefins, vinyl polymers, acrylic polymers, their copolymers or mixtures thereof. The sealing layer, like the print pattern, may also contain the sealing lacquer and an adhesion promoter or primer, for example made of a polyester or a vinyl polymer. The adhesion promoter or primer is advantageously applied to the carrier and the sealing lacquer to the adhesion promoter or primer.

Apart from the sealing lacquers mentioned, dispersions or lacquers as well as solvent-containing, and also solvent-free lacquers, such as polymer-containing lacquers, for example based on PVC, PVC/PVAC, PVDC or acrylates, can be used to form the print pattern. The solid body content in the lacquers should be as high as possible and the fraction of solvents should be as low as possible. Accordingly, the dispersions and lacquers must be suitable for printing machines.

In a method which is suitable for producing covers according to the invention, the sealing layer and the print pattern are applied continuously in the foil running direction onto the carrier material present as a cover foil strip by means of a printing method, the height of the print pattern being 3 to 7 times, preferably 4 to 6 times, the thickness of the sealing layer. The covers are then punched out and stacked.

The thickness of the sealing layer is preferably adjusted to about 2 to 5 μm and the thickness of the print pattern to about 15 to 30 μm.

The sealing layer and the print pattern are expediently applied simultaneously in a single work operation to the carrier material.

To reduce a surface pressure on the punched-out covers in the stack, the print patterns following one another in the foil running direction may be printed onto the carrier material rotated by an angle amount relative to the respective preceding print pattern.

Further advantages, features and details of the invention emerge from the following description of preferred embodiments and with the aid of the drawings, in which schematically:

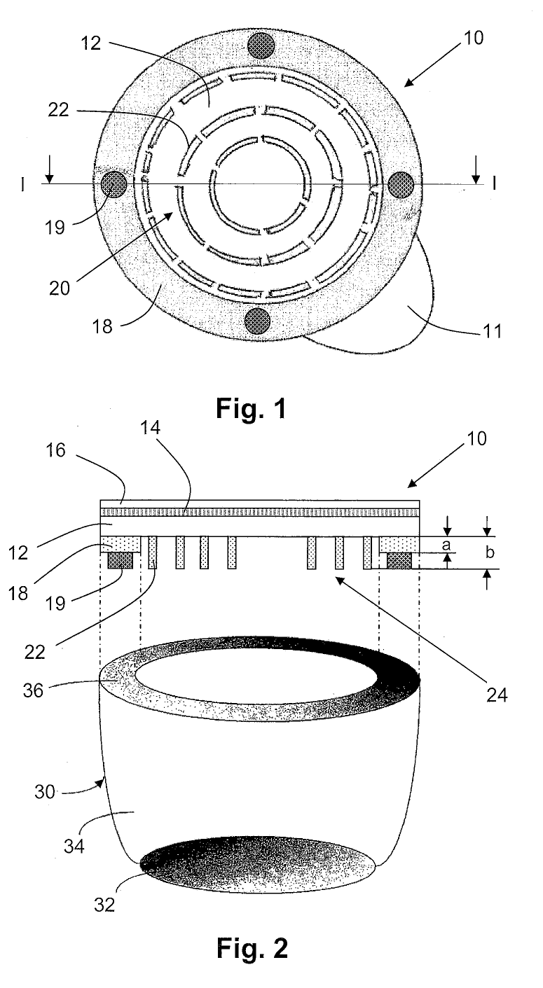

FIG. 1 shows the plan view of the inside of a cover with an annular print pattern;

FIG. 2 shows a section through the cover of FIG. 1 provided for sealing against the edge of a container, along the line I-I;

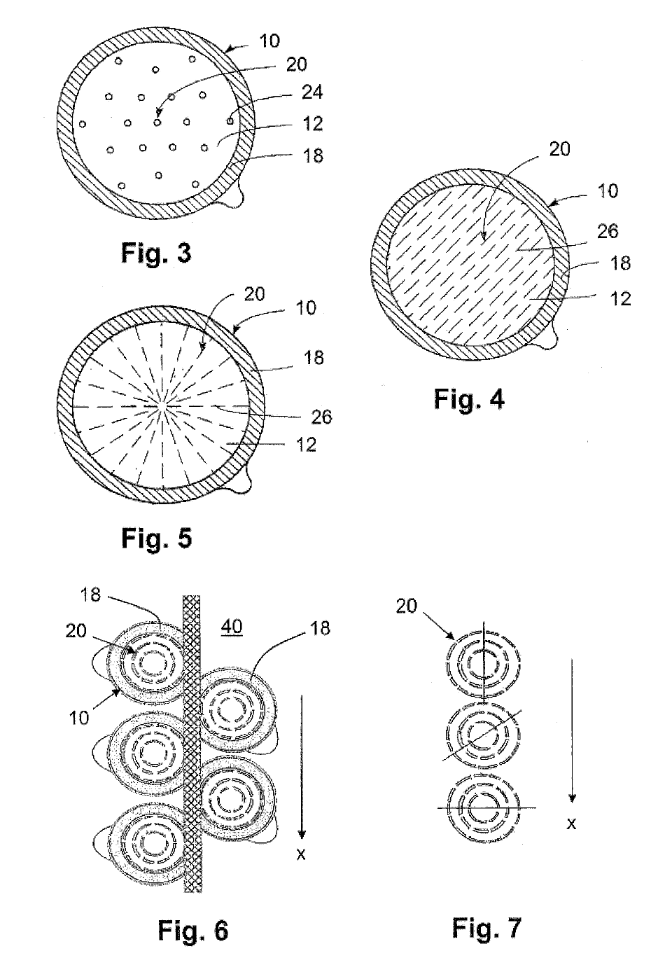

FIGS. 3 to 5 show the plan view of the inside of covers of further print patterns;

FIG. 6 shows the plan view of a foil with an arrangement of covers according to FIG. 1,

FIG. 7 shows a plan view of an arrangement of annular print patterns with a print geometry rotating in the foil running direction.

A cover 10 shown in FIGS. 1 and 2 has a carrier material 12 with outside printing 14 and a protective lacquer layer 16 covering the printing. On the inside of the cover, the carrier material 12 has an annular sealing layer 18 applied by means of a printing method as a sealing lacquer on the carrier material 12 and, inside the region limited by the sealing layer 18, has a print pattern 20, which is also applied by means of a printing method on the carrier material 12, consisting of spacer elements in the form of ring segments 22 located on circles arranged concentrically with respect to one another. Four substantially point-shaped elevations 19 which are arranged regularly distributed over the periphery of the sealing layer 18 project from the annular sealing layer 18. The point-shaped elevations are, for example, shown as circular. Elevations with any desired cross-section in terms of shape, for example a polygonal or rounded point-wise limited cross-section, are also within the scope of the present invention.

As shown in FIG. 2, the annular print image of the sealing layer 18 corresponds to an annular shoulder 36 forming the upper edge termination of a container 30 characterised by a base 32 and a side wall 34 projecting therefrom. After the filling of the container with, for example, a food or a drink, such as yoghurt, jam, dry fruit, a chocolate preparation or another dessert or with drinking water or fruit and vegetable juices, the container 30 is covered with the cover 10, and the cover 10 is sealed against the edge termination of the container 30 by means of the annular sealing layer 18 resting on the shoulder 36 of the container 30. In a region of its periphery, the cover 10 is provided with a pull-tab 11 for peeling the cover 10 sealed to the container edge and therefore to open the container 30.

It can be seen from FIG. 2 that the height a of the printed annular sealing layer 18 is smaller than the height b of the printed print pattern 20 or the ring segments 22 being used as spacer elements. The height of the four point-shaped elevations 19 over the carrier material 12 corresponds to the height b of the printed print pattern 20 or the ring segments 22 being used as spacer elements. On the side of the carrier material 12 directed toward the container 30 or the container inside, the sealing layer 18 is applied in accordance with, or approximately in accordance with, the image of the annular shoulder 36 of the container 30 in the region of the shoulder 36 of the container 30. The sealing layer 18 is accordingly only, or substantially only, applied on the cover 10 on the locations on the carrier material 12 which come into contact with the shoulder 36. This is indicated schematically by the dot-dash lines. In the example shown, the sealing layer 18 has been annularly printed onto the carrier material 12. It is obvious that the print image of the sealing layer 18 can slightly differ from the shoulder 36 of the container 30. With a very wide shoulder 36, the print image of the sealing layer 18 may, for example, be 1 to 50% narrower than the width of the shoulder 36 of the container 30. In order to compensate machine inaccuracies, the area of the print image of the sealing layer 18 may be selected to be 1 to 25% larger than the contact face between the cover 10 and shoulder 36.

The print pattern 20 is, for example, also formed by printing on a sealing lacquer. In the case of corrosion-sensitive cover materials, for example metal foils, it is recommended that a primer be applied beforehand over the whole area of the carrier material 12 as a protection against aggressive filling products.

FIGS. 3 to 5 show covers 10 with various further print patterns 20. In FIG. 3, the individual spacer elements consist of points 24. The print pattern 20 is printed on the carrier material 12 inside the annular sealing layer 18. The print pattern 20 can be seen in FIGS. 4 and 5 in the form of a pattern of individual lines or stripes 26 in a parallel or radial arrangement. The print pattern 20 in this case is also printed inside the annular sealing layer 18 on the carrier material 12.

When the covers 10 are sealed by means of the sealing layer 18 against the shoulder 36 of the container 30, the strength of the sealing seam can be adjusted by the selection of the sealing tool, the sealing pressure and the sealing temperature.

Tearing aids, for example in the form of more weakly sealed part regions in the sealing seam or by zigzag-shaped sealing seam edges, can also be applied to the sealing seam. Instead of the printed-on sealing layer 18, an adhesion with an adhesive, such as a contact adhesive or an adhesive setting under heat and/or pressure can be used, with the requirement that the adhesive can be processed in a printing device and the adhesive can be printed on the carrier material 12.

Owing to the special printing of the cover inside, as an important advantage, a material saving is produced, in particular, in that the sealing lacquer is only applied sparingly to the locations, where it is actually required. Typically, the primer or adhesion promoter is used in quantities of 0.2 to 30 g/m², preferably 1 to 20 g/m² and the sealing layer is applied in quantities of 0.5 to 30 g/m², preferably 1.5 to 20 g/m². As the primer or adhesion promoter and the sealing lacquer generally have to be contained in a solvent for processing in the printing machine, the quantity of solvent to be evaporated is considerably reduced. This is expressed both by the energy requirement and the solvent quantity accumulating. The present method is therefore also advantageous because the production of the cover material requires one less machine operation. The sealing layer 18 does not have to be applied separately as a layer or film, but may be applied when applying the print pattern 20, in the same work operation in the same printing machine. The print pattern 20 spaces the covers 10 apart from one another in a stack, and mutual adhesion of the covers 10 is effectively prevented. Therefore, unembossed covers in the cover stack are suitable to run reliably in packaging machines.

As the sealing layer 18 on the cover 10 is substantially only present in the region of the shoulder 36 of the container 30 to be closed, the risk is also minimised of the constituents of the sealing layer 18 passing into the container contents and, for example, influencing the container contents by odour or taste materials.

As the sealing layer is only applied to the locations of the seal and not over the entire cover region, in the case of transparent cover materials a practically complete transparency is produced, and the properties of a completely transparent carrier material are completely retained. Transparent carrier materials are therefore practically not impaired at all by the sealing lacquer with regard to their transparency.

In the detail shown in FIG. 6 of a cover foil 40 present in strip shape, the print images for the annular sealing layer 18, viewed in the foil running direction x, are arranged overlapping. This overlapping arrangement—the overlap region is shown hatched in the drawing—leads to a saving of cover material, for example of aluminium foil in its use as the carrier material, and therefore to an economically reasonable costing arrangement. If the sealing layer 18 now has the same height as the print pattern 20 inside the region limited by the sealing layer 18, the overlap in the winding of the printed cover film 40 leads to a material build-up and therefore to a constant “thick location” in the wound cover foil, which, for example, leads to a plastic deformation of the aluminium and consequently to an impairment of the running of the cover foil in the machine. With the greater height b of the print pattern 20 according to the invention in comparison to the height a of the sealing layer 18, the above-mentioned material build-up does not occur in the overlap region.

In FIG. 7, on a strip-shaped cover material, consecutive print patterns 20 in the foil running direction x are rotated by a specific angle amount, in each case, relative to the preceding pattern, so after punching to form covers 10, no identical geometries rest above one another. This is achieved by corresponding rotation of the print motifs in the running direction of the printing cylinder within a printing cylinder periphery. With this rotation of the print motifs, the surface pressure of the punched covers in a stack is significantly reduced and material impressions are thereby avoided. The print motif can therefore be implemented in a more material-saving manner with regard to the required sealing lacquer.

The printing cylinder is produced in such a way that the annular sealing layer 18 and the print pattern 20 can be printed with the same lacquer, but in different thicknesses. For this purpose, for example, the print master for the sealing layer 18 is engraved with a height of, for example, 4 μm on the printing cylinder and, for example engraved with a height of 25 μm for the print pattern 20.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A cover made of a carrier material and a sealing layer, having a side which faces inwardly in relation to a container having a shoulder on which the cover is used and is made of a sealing lacquer, which is printed on the carrier material, for closing the container, the side of the carrier material facing inwardly having the sealing layer in the form of a print image corresponding to the shoulder of the container, and a print pattern made of a sealing lacquer or polymer-containing lacquer being printed on the carrier material inside the region limited by the sealing layer, wherein the height (b) of the print pattern printed on the carrier material is greater than the height (a) of the sealing layer.

20. The cover according to claim 19, wherein the height (b) of the print pattern is 3 to 7 times the height (a) of the sealing layer.

21. The cover according to claim 19, wherein the height (a) of the sealing layer is 2 to 5 μm and the height (b) of the print pattern is 15 to 30 μm.

22. The cover according to claim 19, wherein the sealing layer has at least three substantially point-shaped elevations distributed over the periphery of the sealing layer.

23. The cover according to claim 22, wherein the height of the elevations over the carrier material substantially corresponds to the height (b) of the print pattern.

24. The cover according to claim 19, wherein the print pattern is constructed from circular ring segments arranged on circles lying concentrically with respect to one another.

25. The cover according to claim 19, wherein the print pattern is a uniformly or non-uniformly distributed point or line pattern.

26. The cover according to claim 19, wherein the print pattern is formed from polyolefins, vinyl polymers, acrylic polymers, their copolymers or sealing lacquer containing mixtures thereof.

27. The cover according to claim 19, wherein the carrier material contains unembossed thermoplastic plastics material, unembossed cellulose film, unembossed cellulose-containing material, unembossed metal foil or a combination of these materials.

28. The cover according to claim 27, wherein the carrier material contains a combination of at least one thermoplastic plastics material and/or a cellulose film and/or a cellulose-containing material and/or a metal foil in the form of a multi-layer unembossed composite material.

29. The cover according to claim 27, wherein the carrier material contains a barrier layer against the passage of gases, vapours and moisture from a ceramic or metallised layer, a plastics material film or a metal foil.

30. The cover according to claim 1, wherein the print pattern covers 0.1 to 20% of the area of the region of the carrier material limited by the sealing layer.

31. A method for producing covers, each cover being made of a carrier material and a sealing layer, which faces inwardly in relation to a container having a shoulder on which the cover is used and is made of a sealing lacquer, which is printed on the carrier material, to close the container, the inwardly facing side of the carrier material having the sealing layer in the form of a print image corresponding to the shoulder of the container, and a print pattern made of a sealing lacquer or polymer-containing lacquer being printed on the carrier material inside the region limited by the sealing layer, wherein the sealing layer and the print pattern are continuously applied in the foil running direction (x) by means of a printing method on the carrier material present as a cover foil strip, with the covers then being punched out and stacked, wherein the height (b) of the print pattern has 3 to 7 times the thickness (a) of the sealing layer.

32. A method according to claim 31, wherein the thickness (a) of the sealing layer is 2 to 5 μm and the thickness (b) of the print pattern is 15 to 30 μm.

33. A method according to claim 31, wherein the sealing layer has at least three substantially point-shaped elevations distributed over the periphery of the sealing layer.

34. A method according to claim 33, wherein the height of the elevations over the carrier material substantially corresponds to the height (b) of the print pattern.

35. A method according to claim 33, wherein the sealing layer and the print pattern are printed simultaneously in a single work operation on the carrier material.

36. A method according to claim 33, wherein the print patterns following one another in the foil running direction (x) are printed on the carrier material rotated by an angle amount relative to the respective preceding print pattern to reduce a surface pressure on the punched-out cover in the stack.
